(19) United States
(12) Patent Application Publication
(10) Pub. No.: US 2004/0202878 A1
(43) Pub. Date: Oct. 14, 2004

(54) Thermal insulation, weatherproofing and sealing material

(76) Inventor: Joseph Vidal, Jamaica Plain, MA (US)

Correspondence Address: Mr. Joseph Vidal, 3151 Washington St., 2nd Flr., Jamaica Plains, MA, 02130, US

(21) Appl. No.: 10/410,030

(22) Filed: Apr. 9, 2003

(51) Int. Cl. B32B 21/02

(52) U.S. Cl. 428/491; 428/446

(57) ABSTRACT

The present invention generally relates to a composition material that is an excellent insulator, sealer, and weatherproofer. The composition comprises asphalt cement, portland cement, crystalline silica, and fiber.

### BACKGROUND

From the beginning, man has labored against nature in his struggle to survive. Man has worked especially hard in the fight to stay warm—first by discovering that skins of beasts provided protection from the cold, and then by discovering that his dwelling place could be protected and insulated in like manner. As man built shelters to control his environment, he found that these structures, lean-tos, or huts made of wood, leaves, or reeds were effective as thermal barriers. As man progressed, he discovered that walls made with adobe, stone, or wood, and roofs made from grass or palm leaves, provided increased insulation. Even cork, where available, was used to insulate buildings.

Current insulators provide a limited amount of insulation. For example, in summers, most people in the United States, use air conditioners which frequently release Polychlorinated Biphenyl (“PCBs”) into the atmosphere and thus deplete the ozone layer. The ozone layer protects humans and other organisms from negative effects from the sun's radiation, and thus is necessary for good human health.

Similarly, in winters, most people in the United States heat their homes with oil or gas, or both. Both oil and gas are natural resources that are being depleted, and will thus become more and more expensive and scarce with time.

With continual expansion of the population, and depletion of natural resources, there is a growing need for technologies to help preserve energy resources. There is thus a need for insulative materials that provide superior insulation.

Most walls and roofs have foam and/or fiberglass insulation in them to improve thermal properties of the construction. However, such constructions have not been satisfactory, especially from the standpoint of thermal insulating properties. Thermal conductivity of fiberglass is 0.048 W/m.K and of concrete is 0.84 W/m.K. These types of structures and insulating systems must be maintained continuously at very large costs. And the sealing and weatherproofing characteristics of these materials are not effective. Concrete retains moisture by capillarity; and fiberglass insulation frays, attracts impurities and absorbs moisture within its fibers with passage of time, rendering the insulator useless. These physical characteristics of fiberglass insulation and concrete construction methods require extensive maintenance at exuberant costs.

Also, many of the private homes are of the wood frame construction. Other construction examples are the precast units and the curtain wall units. The precast wall units tend to suffer from moisture damage with the passage of time and changes in weather and temperature. Similarly, concrete and aluminum siding walls have a high heat conductivity requiring the need for powerful heating, ventilation and air conditioning units (HVAC), in order to make the living and work spaces environmentally tolerable. The more energy required to cool these spaces, the more energy wastage and environmental pollution we cause. The thermal insulating and weatherproofing properties of the aforementioned construction methods have fallen short of the need for environmental and energy conservation, and accordingly, new building materials are required. In fact, most buildings have not been designed with environment or energy saving considerations in mind at all, and furthermore, many of these structures require continuous insulation and watersealing overhaul.

Additionally, a wide variety of inorganic and organic substances that are currently being used for insulation have been proven to cause grave health problems in humans, most notably asbestos and urea formaldehyde foam. In addition, many insulating foams used today are blown with chemical solvents known as chlorofluorocarbons (or “CFC's”), which have been implicated as being responsible for recent thinning in the ozone layer. Moreover, the best (i.e., the most insulative per unit of mass) synthetic insulation materials used today are organic foam materials, which tend to be flammable. When these organic foam materials burn, they often release extremely toxic fumes.

Besides the obvious health hazards of asbestos, UFFI, and ignited organic foams, certain organic foams, such as polystyrene and polyisocyanate foams, also pose grave environmental risks because they require the use of CFC's during their manufacture.

One additional known insulative material is insulative concretes. However, the insulating properties of the insulative concretes presently on the market are quite small relative to the insulation ability of the materials typically used in the building industry, like glass wool and organic foams. In addition, the available products are still very heavy compared to glass wool and organic foams. Hence, presently manufactured insulating concrete is limited in use and cannot take the place of conventional insulations used in the building industry or in the manufacture of appliances.

Nevertheless, insulating concretes have the advantage of being much safer than most of the insulation materials described above, and are more environmentally benign, since they are essentially comprised of the same components as the earth. In addition, they are fire resistant, nonflammable, and do not emit dangerous or toxic fumes when exposed to fire.

From the foregoing, it will be understood that what are needed are new forms of insulation which are not harmful, or which do not pose serious health risks, to the installer or the building dweller. It will also be understood that there is a need for an insulative material that requires the use of less natural resources, than currently used, to heat homes, offices, and other dwellings. Additionally, there is a need for an insulative material that can also provide weatherproofing and sealing properties, since this need is not currently being met.

Such insulation materials and barriers, along with methods for their manufacture, are disclosed and claimed herein.

### SUMMARY

In accordance with the present invention, there is provided an insulating material comprising asphalt cement, portland cement, crystalline silica, and fiber. In a preferred embodiment, the asphalt cement comprises asphalt cement #30. In one embodiment, the composition comprises between about 33% to about 45% of asphalt cement by weight, about 26% to about 35% of portland cement by weight, about 18% to about 22% of crystalline silica by weight, and about 10% fiber by weight. Preferably, the composition comprises about 45% asphalt cement by weight, about 27% portland cement by weight, about 18% crystalline silica by weight, and about 10% fiber by weight. The fiber is preferably wood.

The invention further provides a panel that comprises the composition of the invention sandwiched between a first shell and a second shell. The first shell and the second shell may be independently selected from the group consisting of a flexible polyuirethane, E.P.D.M. rubber polymer film, paper, reflective foil, aluminum foil, a fiberglass mesh and combinations of at least two materials in this group. Preferably, the first shell is a fiberglass mesh ranging from a ⅛×⅛ grid 0.015 filament to ¼×¼ grid 0.015 filament.

In another embodiment, the invention provides a composition made by mixing asphalt cement and portland cement together at a temperature of at least about 163 degrees Celsius, combining the resulting mixture with crystalline silica at a temperature of at least about 163 degrees Celsius, combining the resulting mixture with wood fiber, wherein the resulting mixture comprises approximately about 33% to about 45% asphalt cement by weight, about 26% to about 35% portland cement by weight, about 18% to about 22% crystalline silica by weight, and about 10% fiber by weight.

The invention also comprises a method of making an insulative material comprising mixing asphalt cement and portland cement together at a temperature of at least about 163 degrees Celsius, and combining the resulting mixture with crystalline silica at a temperature of at least about 163 degrees Celsius, combining the resulting mixture with wood fiber, wherein the resulting mixture comprises approximately about 33% to about 45% asphalt cement by weight, about 26% to about 35% portland cement by weight, about 18% to about 22% crystalline silica by weight, and about 10% fiber by weight.

### OBJECTS OF THE INVENTION

Accordingly, it is a main object of the present invention to provide a superior thermal insulating and sealing material. Such a material or composition may be used in laminate panel form.

It is another object of the present invention to provide an insulating and sealing composition that can be manufactured into panels or other manufactures to make homes, offices, and industrial buildings more environmentally fit, comfortable and energy efficient.

It is a further object of this invention to provide an insulating composition which leads to a reduction in the use of air conditioners, and thus reduces the amounts of dangerous P.C.B. emissions into the atmosphere. Such a reduction is likely to reduce the amounts of contaminating aerosols which harm the ozone layer and the earth's atmosphere as a whole.

It is a further object of the invention to provide an insulating material that provides superior insulation, and thus requires less use of heating systems in cold weather to produce a comfortable environment in the building being insulated.

It is a more specific object of the present invention to provide a thermal insulator and watersealer which permits less heat flow between the inside and outside surfaces thereof than commonly used insulators.

These, together with the other objects and advantages which will become subsequently apparent reside in the details of the invention described herein as more fully hereinafter described and claimed. Reference being had to the accompanying figures and chart.

### FIGURES

FIG. 1 is a schematic of the storage, disbursement and manufacturing process for manufacturing the composition of the invention. The nomenclature for FIG. 1 is shown below:

| | |
|---|---|
| 1 | Silo#1 |
| 2 | Silo#2 |
| 3 | Silo#3 |
| 4 | Silo#4 |
| 5 | Kettle#5 |
| 6 | Kettle#6 |
| 7 | Pump#1 |
| 8 | Pump#2 |
| 9 | Pump#3 |
| 10 | Pump#4 |
| 11 | Intake Valve-1 |
| 12 | Intake Valve-2 |
| 13 | Intake Valve-3 |
| 14 | Intake Valve-4 |
| 15 | Pump-5 |
| 16 | Intake Valve-5 |
| 17 | Output Valve-1 |
| 18 | Output Valve-2 |
| 19 | Output Valve-3 |
| 20 | Output Valve-4 |
| 21 | Line-1 |
| 22 | Line-2 |
| 23 | Line-3 |
| 24 | Line-4 |
| 25 | Line-5 |
| 26 | Ventilation-1 |
| 27 | Ventilation-2 |
| 28 | Ventilation-3 |
| 29 | Ventilation-4 |
| 30 | Ventilation-5 |
| 31 | Filter Unit-1 |
| 32 | Filter-2-OFF-Use in emergency |
| 33 | Filter-3-OFF-USe in emergency |
| 34 | Filter-4-OFF-Use in emergency |
| 35 | Filter-5 |
| 36 | Ventilation-6 |
| 37 | Main Ventilation/Exhaust Unit |
| 38 | Kettle#5-Mixer Moter |
| 39 | Mixer |
| 40 | Filter-6 |

FIG. 2 shows a servo-controlled programmable logic controlled and file-structured fusing and cooling production method utilizing an electro-mechanical apparatus to form panels comprising the composition of the invention. The nomenclature for FIG. 2 is shown below.

| | |
|---|---|
| 41 | Conveyor Drive Motors (2) |
| 42 | FLEXIBLE METAL-LINK CONVEYOR BELT |
| 43 | EXTERIOR SHELL-PRIMARY FEED MECHANISM |
| 44 | INTERIOR SHELL-PRIMARY FEED MECHANISM |
| 45 | EXTERIOR SHELL-SECONDARYFEED MECHANISM |
| 46 | EXTERIOR SHELL GUIDE |
| 47 | EXTERIOR SHELL OPTICAL SENSORS(2) |
| 48 | EJECTOR NOZZLE ACTIVATION SENSORS (2) |
| 49 | INTERIOR MESH PRIMARY FEED MECHANISM/ |
| | INTERIOR MESH SECONDARY FEED |
| | MECHANISM ACTIVATION SENSOR AND GUIDE |
| 50 | PROGRAMMING DIGITAL DISPLACEMENT COUNTER AND |
| | GUILLOTINE ACTIVATOR |
| 51 | EXTERIOR SHELL AUXILIARY GUIDE |
| 52 | EJECTOR DRUM |
| 53 | EJECTOR DRUM VENTILATOR |
| 54 | EJECTOR DRUM SERVO CONTROLLED INTAKE VALVE |
| 55 | HEATED NOZZLE |
| 56 | ADJUSTABLE GUIDE ROLLER |
| 57 | INTERIOR MESH-SECONDARY FEED MECHANISM |
| 58 | INTERIOR MESH GUIDE AND COMPRESSION ROOLER |
| | TO 8 MM |
| 59 | COOLING BLOWER-SYSTEM EXHAUST |
| 60 | COOLING BLOWERS |
| 61 | COMPRESSION CUTTING DISCS |
| 62 | SECONDARY COMPRESSION ROLLER |
| 63 | SENSOR ACTIVATED HYDRAULIC GUILLOTINE |
| 64 | HYDRAULIC LINES (GUILLOTINE) |
| 65 | CONVEYOR DRIVE ROLLERS |
| 66 | CONVEYOR BASE |
| 67 | COMPRESSION ROLLER #18-FROTING & CLEANING |
| | MECHANISM |
| 68 | EXTERIOR SHELL-PRIMARY DRIVE GEAR ASSY |
| 69 | INTERIOR MESH-PRIMARY DRIVE GEAR ASSY |
| 70 | EXTERIOR SHELL PRIMARY FEED DRIVE MOTOR |
| 71 | INTERIOR MESH PRIMARY FEED DRIVE MOTOR |
| 72 | INTER OR MESH GUIDE AND COMPRESSION ROLLER DRIVE |
| | MOTOR |

FIG. 3 is a graphical representation of the controller, actuation, feedback and loop sequence.

FIG. 4 is the power stage specification for the servo system.

FIG. 5 is a graph of % relative humidity in the test structure that was not insulated with the composition of this invention.

FIG. 6 is a graph of % relative humidity in the test structure that was insulated by the composition of this invention.

FIG. 7 is a graph showing % relative humidity in the two test structures as opposed to the ambient relative humidity.

FIG. 8 is a graph showing the differences in % relative humidity between the inside and outside of the test structures.

FIG. 9 is a graph showing fluctuations in temperature between the inside and outside of the structure not insulated by the composition of this invention.

FIG. 10 is a graph showing fluctuations in temperature in the inside and outside of the structure insulated by the composition of the invention.

FIG. 11 is a graph showing temperature fluctuations in both test structures and the outside environment.

FIG. 12 is a graph showing differences in temperature between the inside and outside of the test structure that had no composition of the invention.

FIG. 13 is a graph showing differences in temperature between the inside and outside of the test structure that had the composition of the invention.

### DETAILED DESCRIPTION OF THE INVENTION

This invention specifically relates to a novel composition that can function as an insulator, sealer, and weatherproofer. It can be made into a composite, flexible and malleable laminate. This composition has extremely good insulating, weatherproofing and sealing properties. It does not readily permit thermal equilibrium between two thermal systems thereby being an excellent insulator. Also, due to its composition, it does not allow water and/or moisture to penetrate it.

The composition of this invention is a mixture of four components. In one embodiment, the composition comprises asphalt cement (AC-30), crystalline silica (SiO₂) (CAS#: 14808-60-7), portland cement, and sawdust. In a preferred embodiment, the asphalt cement is asphalt cement #30 and the sawdust is construction grade 4-14 mm long wood fibers. In another embodiment, the portland cement is a Microfine cement.

In a more preferred embodiment, the composition comprises the four components in the following percentages by weight:

asphalt cement: about 33%-about 45%

portland cement: about 26%-about 35%

crystalline silica: about 18%-about 22%

fiber such as sawdust: about 10%

Total: 100%

In an even more preferred embodiment, the composition comprises the four components in the following percentages by weight:

asphalt cement: about 36%-about 42%

pottland cement: about 28%-about 33%

crystalline silica: about 19%-about 21%

fiber such as sawdust: about 10%

Total: 100%

In a most preferred embodiment, the composition comprises the four components in the following percentages by weight:

AC-30: about 44.97%

pottland cement: about 26.80%

crystalline silica: about 18.26%

fiber such as sawdust: about 9.94%

Total: 100%

The composition of the invention preferably has the following physical properties:

Boiling point: 246° C.

Melting point: 125° C.

Freezing point: −30° C.

P_{H}: essentially neutral

Odor: Mild wood scent

Density: 2.60 g/cm³

Maximum thermal conductivity: 0.044 W/m.K.

The composition can be used in a number of ways. In one embodiment, it is made into a panel by sandwiching the composition between a first shell and a second shell.

The first shell of the panel is preferably a fiberglass mesh ranging from a ⅛×⅛ grid 0.015 filament to ¼×¼ grid 0.015 filament. Most preferably, this panel will be constructed and used so that this shell faces the roof or wall to which the panel is appended. Again, the skilled artisan will understand that other size, different meshes, or even different materials such as paper or reflective foil may be used to achieve superior insulation with the composition of the invention.

In one embodiment, the second shell may be a flexible polyurethane, E.P.D.M. rubber polymer film, paper, reflective foil such as aluminum foil, a fiberglass mesh and combinations of at least two materials in this group. In a preferred embodiment, the second shell is a transittable 1/16 of an inch thick white E.P.D.M. 100% polymer compound 60-K-306 or an 1/16 of an inch white polyurethane film. The white polyurethane film or the white E.P.D.M. film makes the thermal insulating and sealing material embodying the present invention waterproof, and its white color makes it highly reflective of sun light, reducing the amount of heat energy and radiant energy, and greatly improving its insulating and waterproofing characteristics. Most preferably, this second shell is appended so that it would be the second facing of the panel when it is installed onto a roof or wall. The skilled artisan will understand that a different gauge material or even a different material can be used as the second shell, and such different gauges or materials are well known to the skilled artisan.

Preferably, the panel is approximately eight millimeters thick, and can be of varying lengths and widths. Multiple panels can be used to seal, insulate or weatherproof living, work, or other spaces, particularly, homes, offices, and industrial buildings. Panels of the invention may be interconnected to make a plurality of wall units together to form a desired matrix. The width and length thereof can be of varying dimensions, as needed, to accommodate design and installation requirements. These units can be preassembled and shipped to the building site to be installed within the building walls and/or roofs.

Installation of the panels containing the composition of the invention can be achieved by using a penetrating fastener, such as a screw, nail, or staple to fasten the panel to the wall studs and/or roof beams, and aligned in a parallel or horizontal plurality with other panels to attain the desired insulating, sealing and weatherproofing nature within the wall unit and roof. Likewise, for roofing installations, the flexible panels will install in the desired matrix by applying a coat of contact cement on the side of the panel facing the roof and another coat of cement on the cleaned roof surface that will be in contact with the panel. Alternately, the panels may be attached by a heating device. In such installations where heat is used, the panels are laid in the desired matrix and then heated until the composition of the present invention softens and adheres to the roof surface when it cools.

The thermal insulating and sealing material embodying this invention does not require caulking materials. The only finishing required is done in situ, comprising overlying seams of two panels with, for example, a 1/16″ thick by 6″ wide pre-glued strip of second shell or facing material to form the seam joint between two panels or tiles of the present invention. The panels and tiles can be molded to fit the contours of the roofs and wall designs to provide an inhibitive insulating and waterproofing protection barrier around the building construction. This reduces heat flow through the roofs and walls, thus, heat transfer through a wall or roof lined with the panels or tiles is slower than in presently known systems.

Similarly, other porous insulating materials such as wafers or panels made from wood or synthetic fiber, may be impregnated with the composition of the present invention and placed inside or outside of walls to provide insulation and weatherproofing.

As the skilled artisan will recognize, the composition of the present invention may be shaped to seal, insulate and/or weatherproof objects other than walls and roofs. For example, a laminate containing the composition of the invention may be wrapped around a pipe, heater duct, air conditioning duct, refrigeration tubing, the outside of a building, or any other thing that would benefit from additional insulating, sealing or weatherproofing properties. Similarly, the laminate can be placed inside a container for the purpose of protecting items that may be placed in the container. In this embodiment, the laminate may line the inside of the container, be a partition within the container or be arranged in some other configuration.

Manufacturing Methodology

The manufacturing process consisted of two stages:

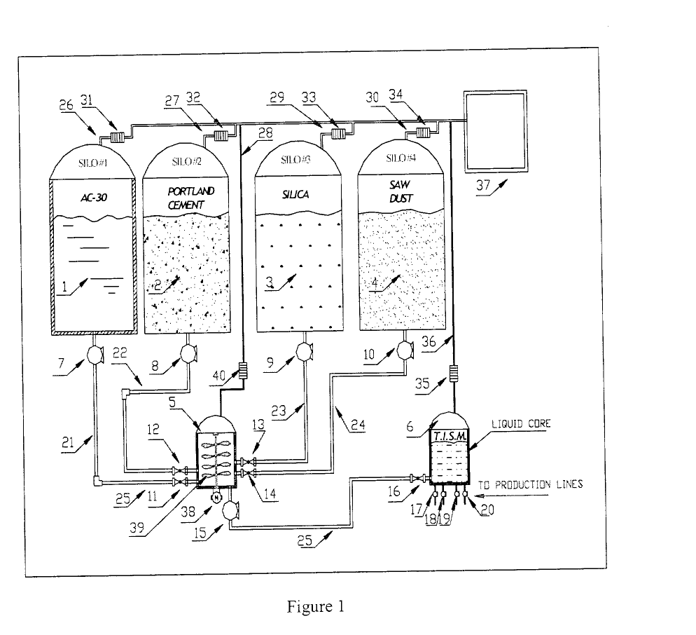

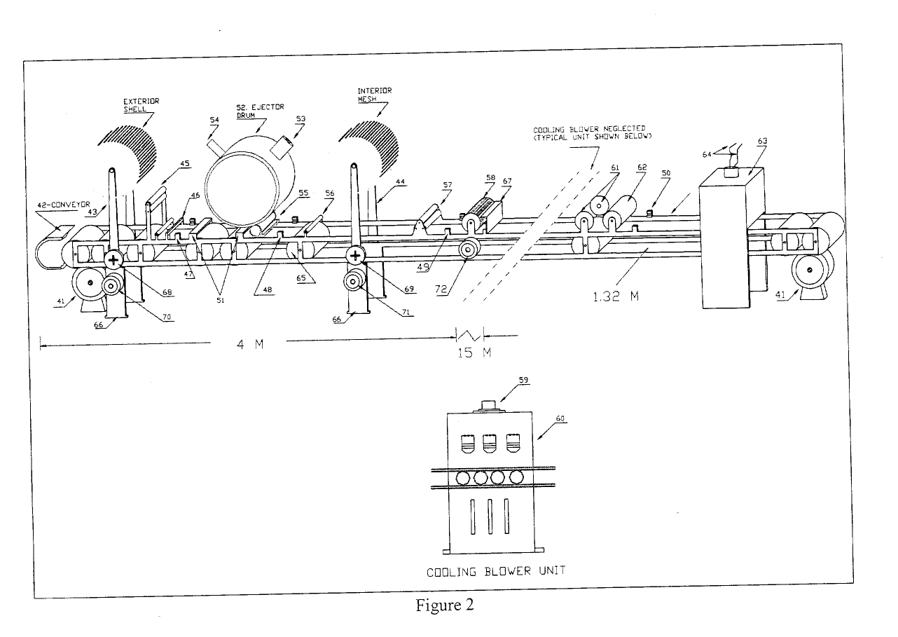

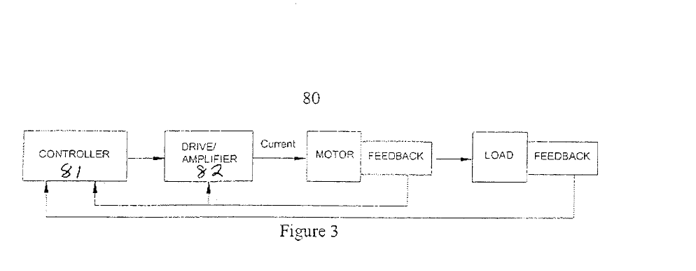

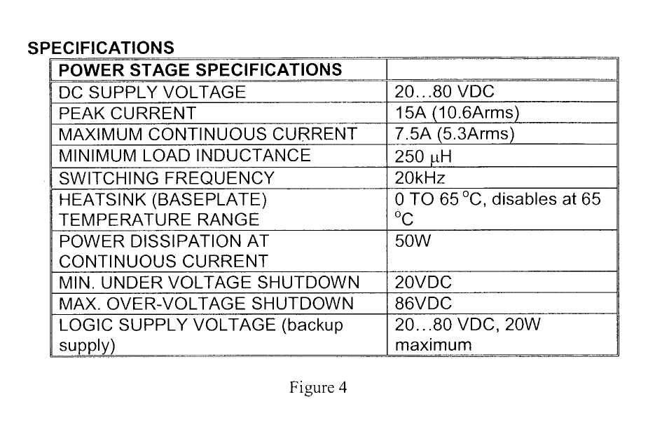

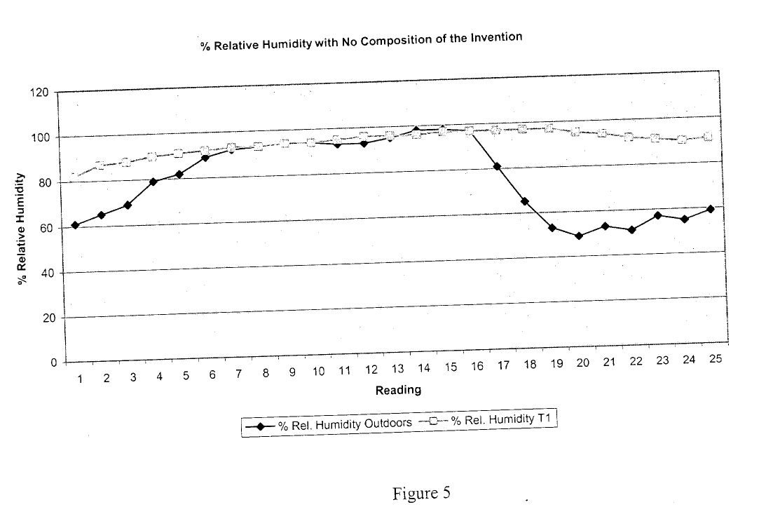

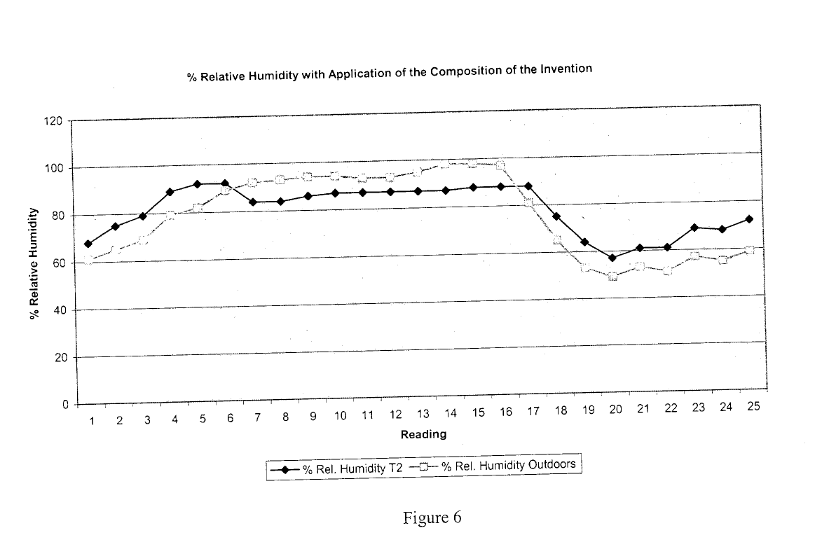

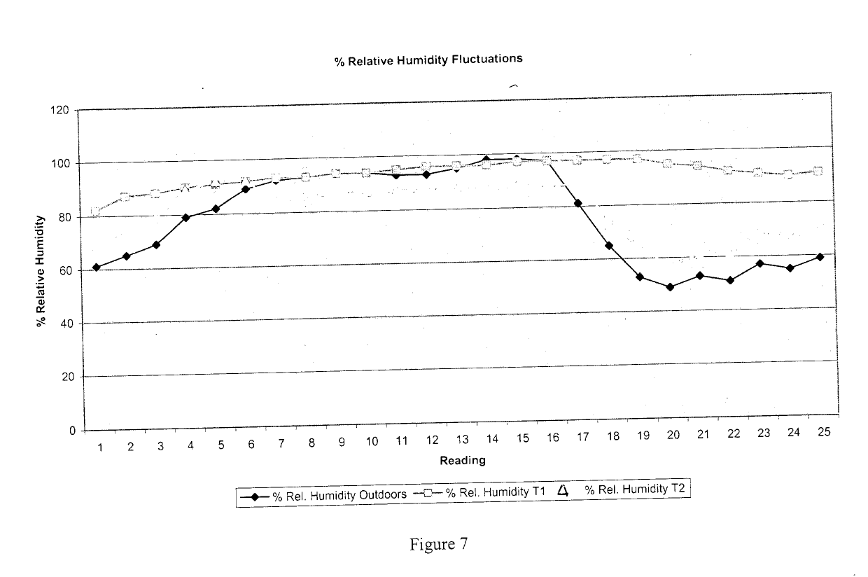

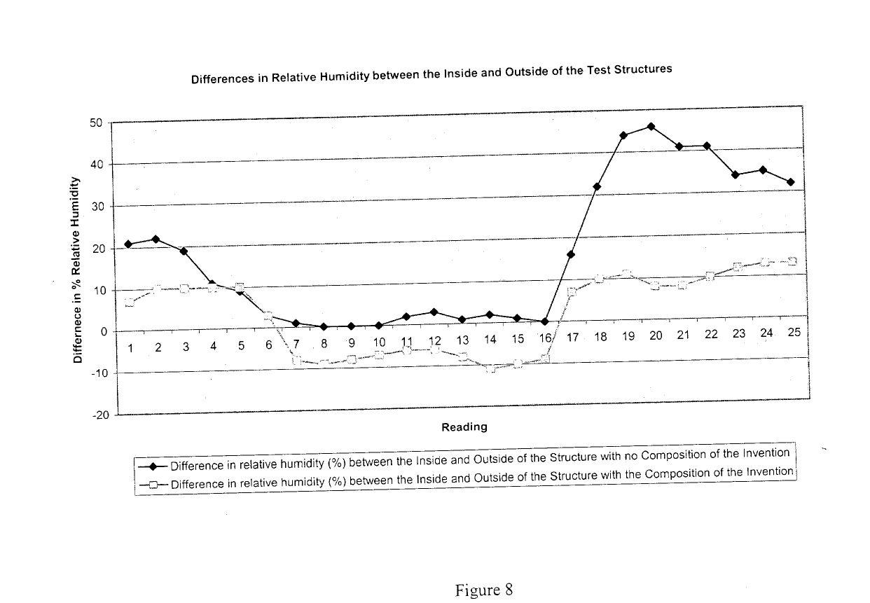

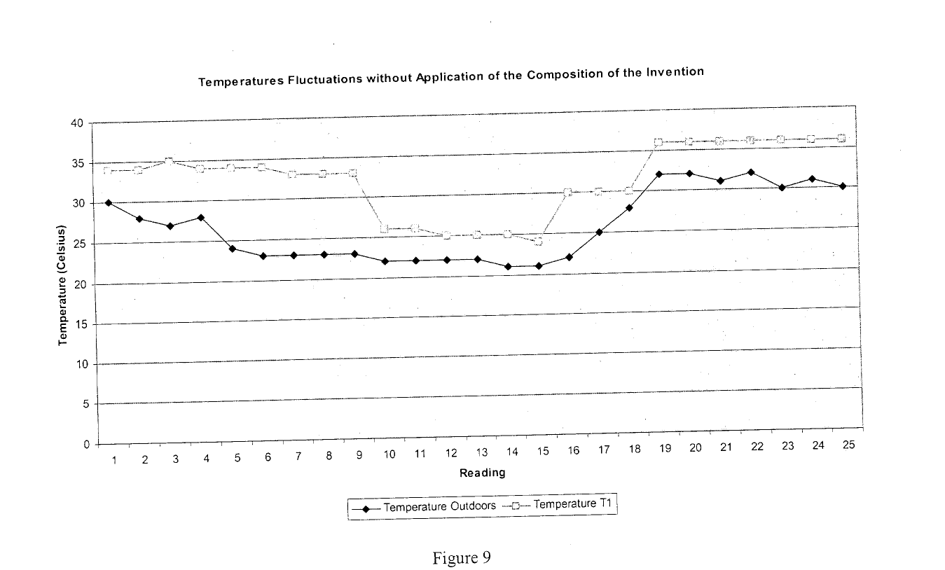

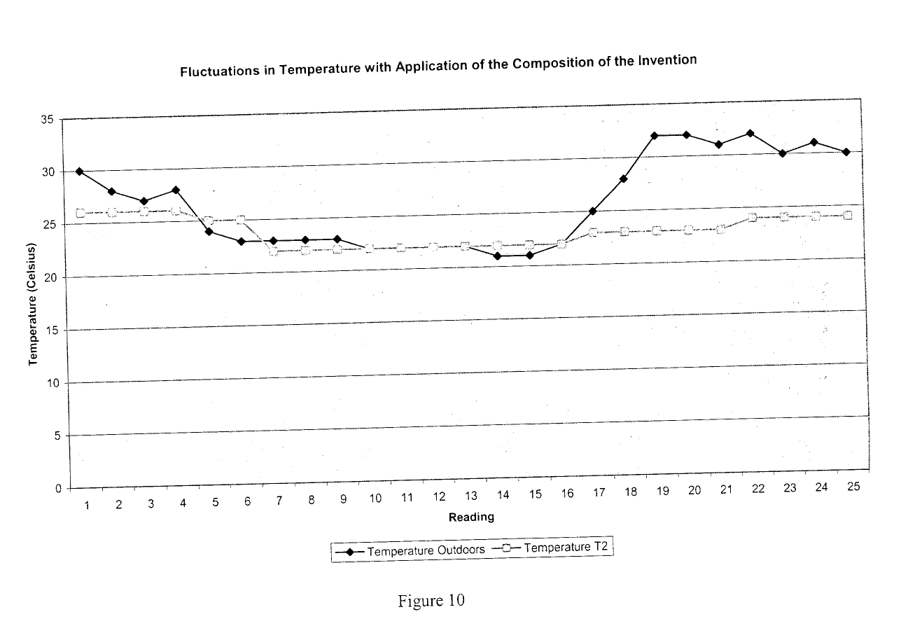

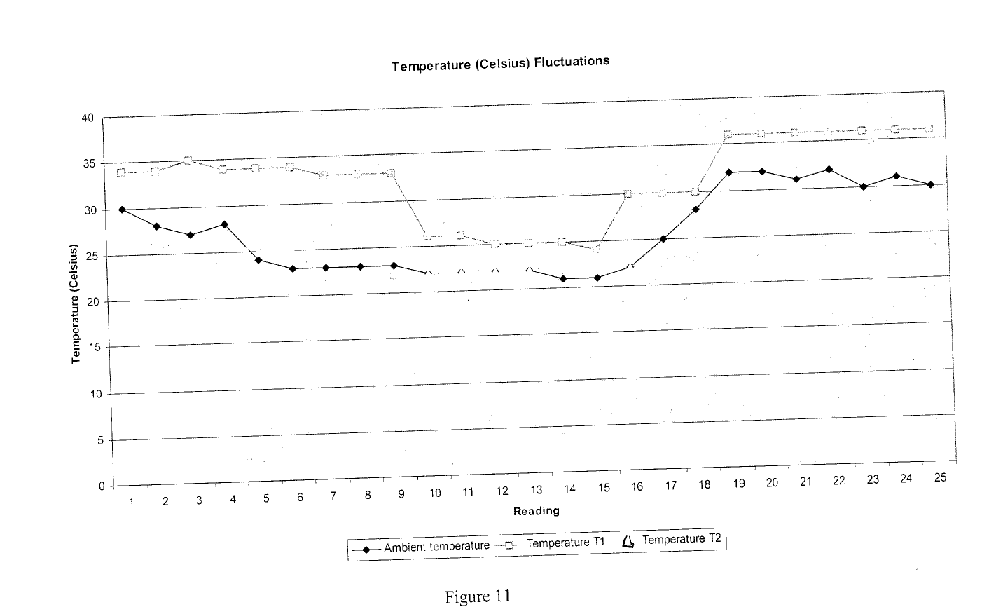

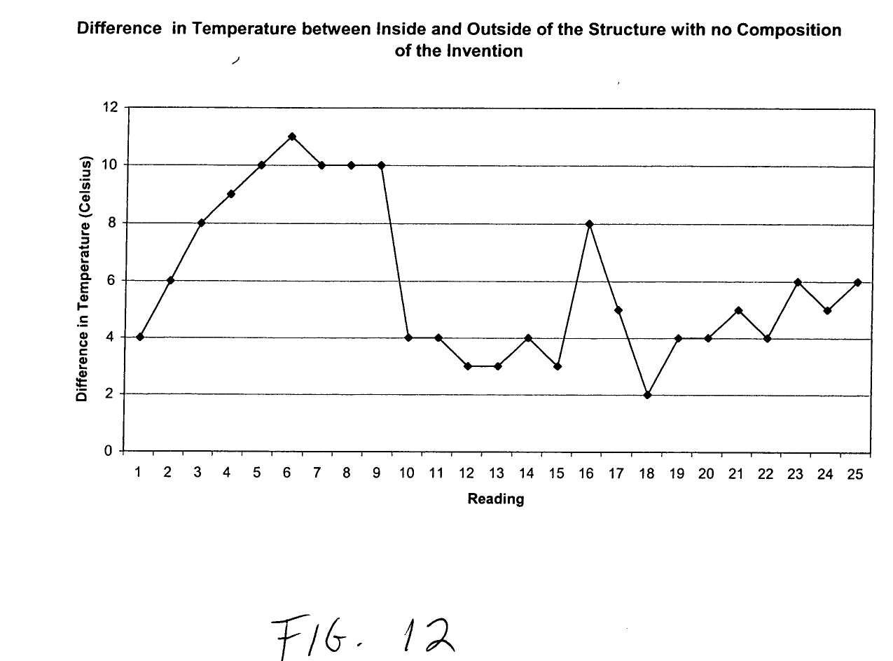

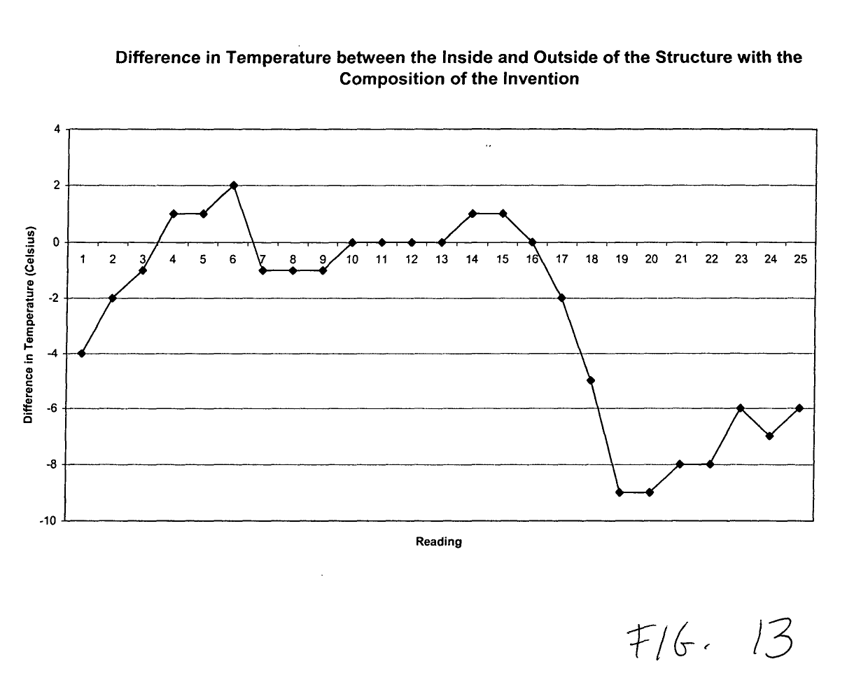

1. The storage and automatic servo-controlled disbursal of raw materials into production (FIG. 1)

2. Stage 2 encompassed the proportional receipt of raw materials into the production system, controlled by servo technology, logic sequencers, specialty pumps, specialty valves and liquid core thermal conduction mixing, feed drums and ejector drums, utilizing heat (FIG. 1).

A third stage was employed to form panels, by sandwiching the composition of the invention between two shells, using a servo-controlled, programmable logic controlled and file-structured fusing and cooling production method utilizing another electro-mechanical invention which forms an integral part of the present invention (FIG. 2 and operation sequence).

Referring to FIG. 1, Silo 1 is a liquid core thermal conduction kettle for storage and disbursal of AC-30 asphalt cement at a continuous temperature of at least about 163.11 degrees Celsius. Silo 1 must be kept at at least about 163.11 degrees Celsius while silo 1 is being used for storage of AC-30. If the AC-30 drops below this temperature, it will cool down and harden.

Silo 2 is a single-walled non-conduction container for storing and disbursing at a controlled rate of Portland cement.

Silo 3 is also a single-walled non-conduction container for storing and proportionally disbursing silica into the production process.

Silo 4 is a single-walled container for storing and volumetric disbursal of 4-14 mm sawdust wood fibers.

The four storage silos were positioned in such a way that their bottoms are at a higher elevation than the top of the mixing kettle 5, the feed kettle 6, and ejector drum 52. This configuration facilitated pumping and feeding of the materials in process.

The AC-30 was pumped by volume utilizing servo technology from silo 1 into another liquid core mixing kettle with a controlled temperature of at least about 163.11 degrees Celsius. The mixing kettle 5 was also equipped with a mixing mechanism 39 driven by a motor 38 set at a rate of 15-20 revolutions per minute. The 163.11 degrees Celsius was maintained while Kettle 5 was on-line.

The portland cement was evacuated by weight into kettle 5, and mixed with the AC-30 at 163.11 degrees Celsius for 10 minutes to produce a cementitious emulsion. The silica was transferred by weight into mixing kettle 5 to combine with the AC-30 and Portland cement at 163.11 degrees Celsius for ten minutes at 15 R.P.M. The 4-14 mm sawdust wood fibers were evacuated by weight into the mixing kettle 5 to mix with the AC-30, Portland cement, and Silica at 163.11 degrees Celsius for 15 minutes and 15 R.P.M.

After 15 minutes, the thermal insulating and sealing solution was pumped to a second kettle, namely the “feed” kettle or kettle 6. Only 96% of the contents in Kettle 5 were transferred into Kettle 6. The temperature of Kettle 6 was automatically maintained at 135.33 degrees Celsius. No mixing mechanism was utilized in Kettle 6.

Kettle 6 was named the “Feed” kettle because it was from this kettle that the production lines were fed. Feed kettle 6 is also a liquid-core conduction kettle. Feed kettle 6 temperature was maintained at 135.33 degrees Celsius while the feed kettle 6 was on-line.

Kettle 6 was automatically controlled to feed into production lines only 96% of its contents. The manufacturing process was designed to provide only 96% of the volumes in the AC-30 silo 1, 96% of the volume in Kettle 5, which is the “mixing Kettle”, 96% of the volume in Kettle 6—the “Feed” Kettle—and 96% of the volume in ejector drum 52.

The 4% of the volumes left over in silo 1, kettle 5, kettle 6, and in the ejector drum 52, maintained the thermal equilibrium in the valves, pumps and transfer lines; preventing the solution at any of these positions in the process, from cooling and hardening, thus, preventing the system from clogging.

Normal Operating Status of the Intake and Output Valves

System Requirements:

1. Processor: Pentium, etc. or higher.

2. Ram: minimum 4 gbytes; 8 gbytes recommended.

3. Fully graphical Windows based application; Windows 95/98/2000/ME/NT

4. Digital PMW servo drives drive the brushed and brushless servomotors. The fully digital drives operate in torque or velocity mode and employ space vector modulation (SVM), resulting in higher bus voltages utilization and reduced heat dissipation. The command source may be supplied internally or externally. Programmable digital and analog inputs/outputs will enhance interfacing with the external controllers and devices, such as the pumps, liquid core heating elements, valves, ejector drums, guillotine and sensors.

The system controls position, velocity, acceleration, temperature and volumes. The control unit 80 contains the algorithms to close the desired loop

| | | Normal Operating |
|---|---|---|
| STAGE | VALVE | Status |
| Silo 1 | Output | Open |
| Kettle 5 | Intake | Closed |
| Kettle 5 | Output | Open |
| Kettle 6 | Intake | Closed |
| Kettle 6 | Output | Open |
| Ejector Drum 52 | Intake | Closed |

and handles all machine interfacing with the input/output terminal. Feedback elements such as tachometers, 1 vdts, encoders and resolvers are utilized to close the various servo loops.

Drive/amplifier 82 translates the low-energy reference signals from the controller 81 into high-energy signals and provide motor voltage and current. A digital drive can replace the controller 81/drive 82 or controller 81/amplifier 82 control system. The reference signal represents either a motor torque or a velocity command and be either analog or digital in nature. For the present invention a 20 . . . 80 VDC command is used as reference signal.

DC brushless trapezoidal servo amplifiers can be used on the present invention to drive brush type and linear motors; also brushless servo motors may be used. The brushless motors have electronic commutators that are isolated from high bus voltages; as a result, higher speeds, higher power density and good performance characteristics are achieved. They operate in current, tachometer, open loop, hall and encoder velocity mode. The amplifiers have potentiometers to adjust loop again, current limit, reference again and offset within the amplifier.

AC sinusoidal servo drives may also be used. PMW servers drive the AC brushless motors and linear AC motors with sine wave currents at a high switching frequency. The onboard digital controller provides commutation by generating the 3 phase sine wave signals from the feedback of the optical encoder. These servos also generate the 3 phase sine wave signals from the feedback of a resolver as well as A, B and I encoder signal outputs. The microprocessor in the control system 80 commutates the motor sinusoidally; will operate in current mode or resolve velocity mode. Potentiometers adjust loop again, current limit, reference again and offset within the amplifier. The offset adjusting potentiometer is used as an onboard input signal for testing purposes.

The skilled artisan will recognize and is aware of the different technologies available to build similar electromechanical systems to accomplish similar goals as described above.

When the contents in Kettle 5 were evacuated into kettle 6, a microprocessor in control system 80 received a signal and registered the completion of the process; the microprocessor sent a signal to start another cycle. The microprocessor monitored the system and also controlled the feed cycle into the production lines from the feed kettle 6 to the ejector drum, 52, and ultimately the laminating, curing and cooling stage.

Once the composition of the present invention was made, panels were made with the composition using digital servo technology, programmable logic control programs (PLCP'S) and file-strictured logic sequencers. A predetermined area of the second shell was loaded onto the fusing machine, onto two (2) separate servo controlled feed mechanisms 43 and 44. The second shell was advanced in such a way that, it was fused to the insulating and sealing composition material by passing the second shell approximately 2 mm under and parallel to the ejector nozzle, 55. The composition was kept at about 120.00 to 130.00 degrees Celsius, thus causing the second shell to fuse to the composition material.

Four (4) Optical sensors 47 and 48, sent a signal of +5V-250 mA @ 20 kHz to the microprocessor in control system 80, when the second shell reached a predetermined position under the ejector nozzle 55 which in response sent an execute signal to the ejector drum 52 to begin dispensing solution in a controlled manner through a 6 millimeter nozzle 55, parallel and about 2 mm above the second shell as it was advanced through the process. The composition of the invention was approximately 6 mm thick on the second shell.

The solution in the ejector drum 52 was kept between 120.00 and 130.00 degrees Celsius. Thus, the second shell and composition of the invention fused together once the composition cooled. The temperature of ejector drum 52 was maintained at 120.00 through 130.00 degrees Celsius while the ejector drum was on-line.

Two (2) Optical sensors 48 and first facing synchronous mechanism 44 were placed 20 centimeters past the ejector nozzle 55. Optical sensors 48 sent a signal to the controller 81 and controller 81, sent an execute signal to the first facing mechanism, 44 to start feeding the mesh at a controlled rate of speed.

The mesh was automatically guided to the desired position over the second shell having the composition of the invention on it. The panel containing the second shell, composition and mesh was moved to the compression roller 58 by conveyer 42. Compression roller 58 compressed the panel to a total thickness of 8 mm using hydraulic force, from the second shell.

The fused panels were then moved in a controlled fashion into a ventilating and cooling blower unit 60. Air was blown onto the first mesh facing side of the panel for curing and cooling at a controlled rate.

The load was moved away from cooling blowers 60 and passed through two trimming cutting discs 61 at both extremes of the width of the load, thus trimming the panel's width.

The load was then automatically advanced a preprogrammed length by the implementation of digital displacement counters 50. When digital counters 50 reached their vector sum, they sent a signal to controller, 80 indicating the panel's length. In response, the processor sent a signal to the guillotine mechanism 63, instructing it to execute a cut.

The system then looped back to the beginning and started laminating, fusing, curing and trimming a second panel.

Fusing & Cooling Electromechanical Operations Sequence

FIGS. 3 and 4 show a fusing and cooling operations sequence for a new electromechanical, fully automated machine which forms part of the present invention. With the utilization of sinusoidal and trapezoidal digital servo drives, DC and AC motors, thermal heating elements and sensors; we controlled temperature, load movement, and electromagnetic actuation. This system is controlled by DSP microprocessor technology, utilizing programmable logic control programs (PLCP'S); file-structured logic sequencers, thermal and optical sensors, and operator interface to effect system operation.

The second shell was loaded onto the second shell primary feed mechanism 43, or was manually placed on the conveyer 42, and guided through the second shell secondary feed mechanism 45, and into the second shell guide 46. The operator input through interface command “standby.” This command prompts the processor and clears all previous commands.

The first facing fiberglass mesh was also hoisted onto the first mesh primary feed mechanism 44. It was guided and advanced through the first mesh secondary feed mechanism 57, and held in place by the first mesh compression roller 58.

By operator command: “START,” through the use of the operator interface, the second shell mechanism 43 advanced the second shell at a controlled rate, and by means of actuators 70, the primary feed mechanism, 43, which is driven by the second shell primary gear assembly 68, fed the second shell past optical sensors 47. Optical sensors 47, sent a signal of +5V-250 mA to the processor on control system 80, which activated the motors 41, which move the conveyer 42, forward at a speed of 1.6 centimeters per second.

The operator commands by use of the operator Interface “AUTOFEED” and “START” simultaneously.

The second shell was advanced through the fusing mechanism at a controlled rate of speed of 1.6 cm/s and guided by the conveyer edge guides 46 and second shell guides 51 2 millimeters below and parallel to the ejector drum nozzle 55.

Four centimeters (4 cm) past the ejector nozzle 55, a pair of opposing optical sensors 48 activated the ejector nozzle 55 to start ejection of the composition of the invention at a controlled rate and temperature across the desired width of the second shell. The skilled artisan will understand that ejector nozzles 55, may be of varying lengths and sizes as needed.

Eight centimeters (8 cm) past the ejector nozzle 55, an adjustable guide 56, above the conveyer 42, guides the panel under the first mesh primary mechanism 44. This mechanism, like the second shell primary mechanism 43 is also gear and chain driven by motor 71, activated by sensors 49 and synchronously with motor, 72.

The panel also passed under the first mesh secondary mechanism 57. Eight centimeters (8 cm) past the secondary mesh mechanism 57, the panel reached a fourth set of guides 49, and a third set of optical sensors 49. Optical sensors 49 activated motor 71, and motor, 72; which provided the work which moved the first mesh primary drive gear assembly 69. The first mesh primary feed mechanism 44, first mesh secondary feed rollers mechanism 57, and the first mesh guide and compression roller 58.

As the panel was moved through the compression roller 58, the first mesh was guided over the composition of the invention, and compressed to the first surface of the composition. The compression roller 58, compressed the second shell, the composition, and the first mesh facing to a total thickness of 8 millimeters.

At this moment, the composition was fused into a single panel 8 mm thick with the second shell on the one side and compressed and fixed to the opposite side.

The algorithms in the control unit 80 continued the feedback and loop cycle indefinitely, absent of any malfunction: a system shunt, depletion of raw materials or interruption by interface command.

The panel continues into the curing and cooling stage. The cooling ventilators 60 removed any and all residual fumes and heat. The panel continued by conveyer 42 out of the curing and cooling system 60 and was guided to the adjustable compression cutting discs 61. The cutting discs 61 trimmed the panel to a specified width. The panel was advanced in a controlled fashion and moved into the secondary compression roller 62.

The panel was compressed for a second time to a thickness of 8 mm. Six centimeters (6 cm) past the secondary compression roller 62, a set of digital displacement counters 50 measured a preprogrammed length of panel past the guillotine 63. When the displacement vector was reached, the processor sent a command to the hydraulically driven guillotine 63 to execute a “cut.” The guillotine 63 rammed down, cutting the panel.

The digital counters, 50 generated another vector-sum signal (R_{T}) at R_{T}+n to “execute” another “cut” and so on.

Feedback.

Loop.

End.

Experimentation

The composition of the invention were prepared as described above, with the following materials.

asphalt cement #30 (AC-30)=3,620 grams

crystalline Silica (SiO₂)=1,470 grams (CAS#:14808-60-7)

portland cement=2,160 gram

Sawdust construction grade 4-14 mm long wood fibers=800 grams.

The composition was sandwiched between one square meter of an 1/16 of an inch white polyurethane or one square meter of 1/16 of an inch white E.P.D.M. polymer compound #60-K-306 with a #70 hardness, and one square meter fiberglass mesh ⅛″×⅛″ grid −0.015 filament gauge to make a panel.

Two identical concrete and block structures were built. They were labeled for identification and experimental notations purposes, “T₁” and “T₂”. Both structures were finished with a one inch coat of concrete stucco on the inside and outside. The flooring and roofs were made in both instances of ten centimeter thick concrete. For each structure, the interior walls were finished with standard rail and stud construction. One-half inch gypsum boards and finishing compound was used to complete the interiors; and both structures were painted with three (3) coats of white latex paint, on the outside and inside of each structure. T₁ did not have the composition of the invention applied. Structure T₂ was completely lined within the insides of the walls and ceiling, with two (2) parallel panel layers containing the composition of the invention—with a two (2) inch insulating air spacing between them. Drywall screws were utilized to attach the panels into permanent position within the walls and ceiling of T₂.

Both structures were built side-by-side, fifteen meters apart, and both facing the east. They were both built in a tropical environment, where exposure to sunlight is much longer than in the United States and other parts of the Northern Hemisphere.

Dimensions of each of the structures were: 5.01 meters wide×5.01 meters long×3.14 meters high. A pine door was placed on the right corner of each structure, facing east. Each door was 2.52 meters high by one meter wide. A pine window, one meter by one meter, was placed in the center of the southern wall of each structure. All windows and doors were kept closed during the entire time of the experiment.

One meterological weather station was placed inside each structure in the middle of the structure. A second meteorlogical weather station was placed ten feet in front of each structure.

Daily readings were taken of the temperature and relative humidity inside and outside of both strictures. The readings of temperatures and relative humidity were taken once per day at incrementing time intervals during a period of twenty-five days.

The experiment was conducted to establish the physical and thermodynamic characteristics and performance of the composition of the invention under tropical conditions exhibiting high relative humidity and hot climate. The structures were unoccupied and no heating, ventilation or air conditioning was used during the length of the experiment.

The experiment began at 4:00 PM Monday May 13, 2002 and concluded at 4:00 PM, Thursday Jun. 6, 2002. A summary of the results is shown below.

| | | | | | | | | | Relative | Relative | | Relative | Relative | |
|---|---|---|---|---|---|---|---|---|---|---|---|---|---|---|
| | | | T₁ external | T₁ internal | | T₂ external | T₂ internal | | humid- | humid- | | humid- | humid- | |
| | Day | | temper- | temper- | | temper- | temper- | | ity | ity | | ity | ity | |
| | ((“Reading”) | | ature | ature | | ature | ature | | outside | inside | | outside | inside | |
| Date | in Figures) | Time | (Celsius) | (Celsius) | | (Celsius) | (Celsius) | | T₁ (%) | T₁ (%) | | T₂ (%) | T₂ (%) | |
| May 13 | 1 | 4:00 PM | 30 | 34 | 4 | 30 | 26 | −4 | 61 | 82 | 21 | 61 | 68 | 7 |
| May 14 | 2 | 5:00 PM | 28 | 34 | 6 | 28 | 26 | −2 | 65 | 87 | 22 | 65 | 75 | 10 |
| May 15 | 3 | 6:00 PM | 27 | 35 | 8 | 27 | 26 | −1 | 69 | 88 | 19 | 69 | 79 | 10 |
| May 16 | 4 | 7:00 PM | 28 | 34 | 9 | 25 | 26 | 1 | 79 | 90 | 11 | 79 | 80 | 10 |
| May 17 | 5 | 8:00 PM | 24 | 34 | 10 | 24 | 25 | 1 | 82 | 91 | 9 | 82 | 92 | 10 |
| May 18 | 6 | 9:00 PM | 23 | 34 | 11 | 23 | 25 | 2 | 89 | 92 | 3 | 89 | 92 | 3 |
| May 19 | 7 | 10:00 PM | 23 | 33 | 10 | 23 | 22 | −1 | 92 | 93 | 1 | 92 | 84 | −8 |
| May 20 | 8 | 11:00 PM | 23 | 33 | 10 | 23 | 22 | −1 | 93 | 93 | 0 | 93 | 84 | −9 |
| May 21 | 9 | 12:00 AM | 23 | 33 | 10 | 25 | 22 | −1 | 94 | 94 | 0 | 94 | 86 | −8 |
| May 22 | 10 | 1:00 AM | 22 | 26 | 4 | 22 | 22 | 0 | 94 | 94 | 0 | 94 | 87 | −7 |
| May 23 | 11 | 2:00 AM | 22 | 26 | 4 | 22 | 22 | 0 | 93 | 95 | 2 | 93 | 87 | −6 |
| May 24 | 12 | 3:00 AM | 22 | 25 | 3 | 22 | 22 | 0 | 93 | 96 | 3 | 93 | 87 | −6 |
| May 25 | 13 | 4:00 AM | 22 | 25 | 3 | 22 | 22 | 0 | 95 | 96 | 1 | 95 | 87 | −8 |
| May 26 | 14 | 5:00 AM | 21 | 25 | 4 | 21 | 22 | 1 | 98 | 96 | 2 | 98 | 87 | −11 |
| May 27 | 15 | 6:00 AM | 21 | 24 | 3 | 21 | 22 | 1 | 98 | 97 | 1 | 98 | 88 | −10 |
| May 28 | 16 | 7:00 AM | 22 | 30 | 8 | 22 | 22 | 0 | 97 | 97 | 0 | 97 | 88 | −9 |
| May 29 | 17 | 8:00 AM | 25 | 30 | 5 | 25 | 23 | −2 | 81 | 97 | 16 | 81 | 88 | 7 |
| May 30 | 18 | 9:00 AM | 28 | 30 | 2 | 28 | 23 | −5 | 65 | 97 | 32 | 65 | 75 | 10 |
| May 31 | 19 | 10:00 AM | 32 | 36 | 4 | 32 | 23 | −9 | 53 | 97 | 44 | 53 | 64 | 11 |
| June 1 | 20 | 11:00 AM | 32 | 36 | 4 | 32 | 23 | −9 | 49 | 95 | 57 | 49 | 57 | 8 |
| June 2 | 21 | 12:00 PM | 31 | 36 | 5 | 31 | 23 | −8 | 53 | 94 | 61 | 53 | 61 | 8 |
| June 3 | 22 | 1:00 PM | 32 | 36 | 4 | 32 | 24 | −8 | 51 | 91 | 61 | 51 | 61 | 10 |
| June 4 | 23 | 2:00 PM | 30 | 36 | 6 | 30 | 24 | −6 | 57 | 91 | 69 | 57 | 69 | 12 |
| June 5 | 24 | 3:00 PM | 31 | 36 | 5 | 31 | 24 | −7 | 55 | 90 | 68 | 58 | 68 | 13 |
| June 6 | 25 | 4:00 PM | 30 | 36 | 6 | 30 | 24 | −6 | 59 | 91 | 72 | 59 | 72 | 13 |
| Differ- | | | | | | | | | | | 16.64% | | | 2.4% |
| ence | | | | | | | | | | | | | | |

The present invention has excellent thermodynamic properties as compared to known systems. Furthermore, the thermal insulating and sealing material embodying the technology of this invention, reduces energy consumption by about seventeen percent (17%) for cooling and heating; and at the same time, reduces the amounts of harmful PCBs and other harmful ozone depleting aerosols from releasing into the atmosphere.

The reduction in thermal energy also lowers the BTU requirements of air conditioning and heating systems. Otherwise, without the implementation of the insulating system embodying the present invention, the energy consumption to bring the systems to a reasonable level of comfort would be increased exponentially.

The laminate panels of the present invention also exhibit excellent acoustical characteristics, such as low-sound transmissions and high-level sound absorption.

The thermal insulation and sealing panels embodying the present invention require only one installation and zero maintenance or overhaul in comparison to presently known systems. This resulting in reductions in costs, maintenance and labor. but most importantly, reduces the amounts of dangerous emissions into the atmosphere by lowering B.T. U. requirements by about 17% during cooling and heating of buildings or homes.

The composition of the present invention has excellent thermodynamic characteristics. It showed zero linear expansion and zero volume expansion.

The panels containing the composition of the invention reduced heat flow by −27.80% as compared in T₁ and T₂. (The figure of 17% is used above as a reasonable estimate of the savings in HVAC costs and energy loss likely to be experienced by users of the composition).

```
Heat Flow
  T1  = ΔQ/ΔT  = A (Th − Tc)/L/k
          = 88.02 m sup.2 (6° C.)/0.1524/0.84
  = 528.12 m sup.2. ° C./0.1814 J/s
      = 2911.36 J/s = 2911.36 W  POWER
  2911.36 J/s/4.19 × 10 sup. 3 J/Kcal = 2911.36 J/s/41900 J/Kcal =
0.0695 Kcal/s,
or (0.695 Kcal/s)(3600 s/h) = 250.20 Kcal/h ENERGY
or (250.20 Kcal/h) (3.24 BTU/h) = 810.65 BTU/m.h.
```

T1 with fiberglass insulation:

```
T1  =  ΔQ/ΔT = A (Th − Tc)/(L1/K1 + L2/K2)
      = 88.02 m sup. 2 (6° C.)/0.1524/0.84/0.0762/0.048 =
528.12/1.7714
      = 298.14 J/s = 298.14 W  POWER
      294.14 J/s/41900 J/Kcal = 0.007 Kcal/s.
      or (0.007 Kcal/s) (3600 s/h) = 25.20 Kcal/h. ENERGY
      or (25.20 Kcal/h) (3.24 BTU/h) = 81.65 BTU/m.h.
```

| | |
|---|---|
| T2 = ΔQ/ΔT | = A (Th − Tc)/(L1/k1 + L2/K2 + |
| L3/K3) | |
| | = 88.02 m sup.2 (6° C.)/0.1524/0.84 + |
| 0.016/0.044 + 0.0508/0.023 | |
| | = 528.12/m sup.2 × ° C./0.1814 + 0.3636 + |
| 2.2086 | |
| | = 528.12/2.7536 = 191.79 J/s = |
| 191.79 W. | |
| | POWER |
| | = 191.79 J/s/41900 J/Kcal = 0.004 Kcal/s. |
| | or, (0.004 Kcal/s) (3600 s/h) = 14.40 Kcal/h. |
| | ENERGY |
| | or, (14.40 Kcal/h) (3.24 BTU/h) = 46.66 |
| BTU/m.h. | |

They reduced the temperature of T₂ by −26.60% as compared to T₁, and the outdoor ambient temperature readings. The change in relatively humidity of T₂ is only 2.4% as compared to the change in relative humidity of T₁, which is 16.64%, a −14.24% reduction in relative humidity was reached in T₂ by the panel system.

A seventeen percent reduction in energy consumption was recorded by the utilization of the TISM system. Therefore, utilization of panels having the composition of the present invention can result in about a 17% reduction in HVAC costs.

Additionally, the composition has excellent weatherproofing and sealing properties.

As this invention may be embodied in several forms without departing from the spirit or essential characteristics thereof, the present embodiment is therefore illustrative and not restrictive. Since the scope of the invention is defined by the appended claims rather than by the description preceding them, and all changes that fall within the metes and bounds of the claims or that form their functional as well as cojointly cooperative equivalents are therefore intended to be embraced by these claims.

I claim:

1. An insulating material comprising asphalt cement, portland cement, crystalline silica, and fiber.

2. The material of claim 1, wherein the asphalt cement comprises asphalt cement #30.

3. A material comprising between about 33% to about 45% of asphalt cement by weight, about 26% to about 35% of portland cement by weight, about 18% to about 22% of crystalline silica by weight, and about 10% fiber by weight.

4. The material of claim 3, comprising about 45% asphalt cement by weight, about 27% portland cement by weight, about 18% crystalline silica by weight, and about 10% fiber by weight.

5. The material of claim 3, wherein the fiber is wood fiber.

6. A panel comprising the composition of claim 3, wherein said composition is sandwiched between a first shell and a second shell.

7. The panel of claim 5, wherein the first shell and the second shell is independently selected from the group consisting of a flexible polyurethane, E.P.D.M. rubber polymer film, paper, reflective foil, aluminum foil, a fiberglass mesh and combinations of at least two materials in this group.

8. The panel of claim 5 wherein said first shell is a fiberglass mesh ranging from a ⅛×⅛ grid 0.015 filament to ¼×¼l grid 0.015 filament.

9. A composition made by:
mixing asphalt cement and portland cement together at a temperature of at least about 163 degrees Celsius,
combining the resulting mixture with crystalline silica at a temperature of at least about 163 degrees Celsius;
combining the resulting mixture with wood fiber, wherein the resulting mixture comprises approximately about 33% to about 45% asphalt cement by weight, about 26% to about 35% portland cement by weight, about 18% to about 22% crystalline silica by weight, and about 10% fiber by weight.

10. A method of making an insulative material comprising:
mixing asphalt cement and portland cement together at a temperature of at least about 163 degrees Celsius,
combining the resulting mixture with crystalline silica at a temperature of at least about 163 degrees Celsius;
combining the resulting mixture with wood fiber, wherein the resulting mixture comprises approximately about 33% to about 45% asphalt cement by weight, about 26% to about 35% portland cement by weight, about 18% to about 22% crystalline silica by weight, and about 10% fiber by weight.
